(19) United States
(12) Patent Application Publication
(10) Pub. No.: US 2006/0273654 A1
(43) Pub. Date: Dec. 7, 2006

(54) Bicycle wheel rim

(76) Inventor: Tung-Kuei Lien, Taichung Hsien (TW)

Correspondence Address: The Law Office of Kenneth C. Brooks, P.O. Box 10417, Austin, TX, 78766-1417, US

(21) Appl. No.: 11/145,195

(22) Filed: Jun. 3, 2005

(51) Int. Cl. B60B 1/02

(52) U.S. Cl. 301/95.101

(57) ABSTRACT

A bicycle wheel rim for assembly with a plurality of spokes includes a wheel rim body having two opposite annular sidewalls, an annular intermediate wall connected between the sidewalls, and an annular rib connected between the sidewalls opposite to the intermediate wall. The intermediate wall is formed with a plurality of angularly spaced-apart spoke holes, each of which is adapted to retain a corresponding one of the spokes. Each sidewall is formed with a plurality of angularly spaced-apart cutout portions. Access to an interior space confined by the sidewalls, the intermediate wall and the rib is permitted through the cutout portions for attachment of the spokes to the spoke holes, respectively.

### BACKGROUND OF THE INVENTION

1. Field of the Invention

The invention relates to a wheel rim, more particularly to a bicycle wheel rim.

2. Description of the Related Art

Referring to FIG. 1, a conventional bicycle wheel rim 1 includes a wheel rim body 10 for mounting of a bicycle tire 2 and a plurality of spokes 31. The wheel rim body 10 has two spaced-apart sidewalls 11, an intermediate wall 12 interconnecting the sidewalls 11, an annular rib 13 connected between the sidewalls 11 opposite to the intermediate wall 12, a plurality of through holes 14 formed in the rib 13, and a plurality of spoke holes 15 formed in the intermediate wall 12 and aligned with the through holes 14, respectively.

During assembly, one end 311 of each spoke 31 is inserted through the respective spoke hole 15, after which a screw bolt 32 is inserted through the through hole 14 using a tool so as to engage threadedly the end 311 of the corresponding spoke 31 and be positioned on the intermediate wall 12. Finally, the bicycle tire 2 is sleeved on the wheel rim body 10 between the sidewalls 11.

When one of the spokes 31 is damaged and has to be replaced, the bicycle tire 2, which includes an inner tire body 21 and an outer tire body 22, has to be removed first in order to permit the tool to access the respective through hole 14 and loosen engagement between the corresponding screw bolt 32 and the damaged spoke 31. After replacement of a new spoke 31, the bicycle tire 2 is again mounted to the bicycle wheel rim 1.

Although the aforementioned conventional bicycle wheel rim 1 can achieve its intended purpose, replacement of a new spoke 31 is inconvenient since the entire bicycle tire 2 must first be removed.

### SUMMARY OF THE INVENTION

Therefore, the object of the present invention is to provide a bicycle wheel rim that can permit easy assembly and replacement of spokes.

According to this invention, a bicycle wheel rim for assembly with a plurality of spokes comprises a wheel rim body having two opposite annular sidewalls, an annular intermediate wall connected between the sidewalls, and an annular rib connected between the sidewalls opposite to the intermediate wall. The intermediate wall is formed with a plurality of angularly spaced-apart spoke holes, each of which is adapted to retain a corresponding one of the spokes. Each of the sidewalls is formed with a plurality of angularly spaced-apart cutout portions, whereby access to an interior space confined by the sidewalls, the intermediate wall and the rib is permitted through the cutout portions for attachment of the spokes to the spoke holes, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional bicycle wheel rim and a bicycle tire mounted thereon;

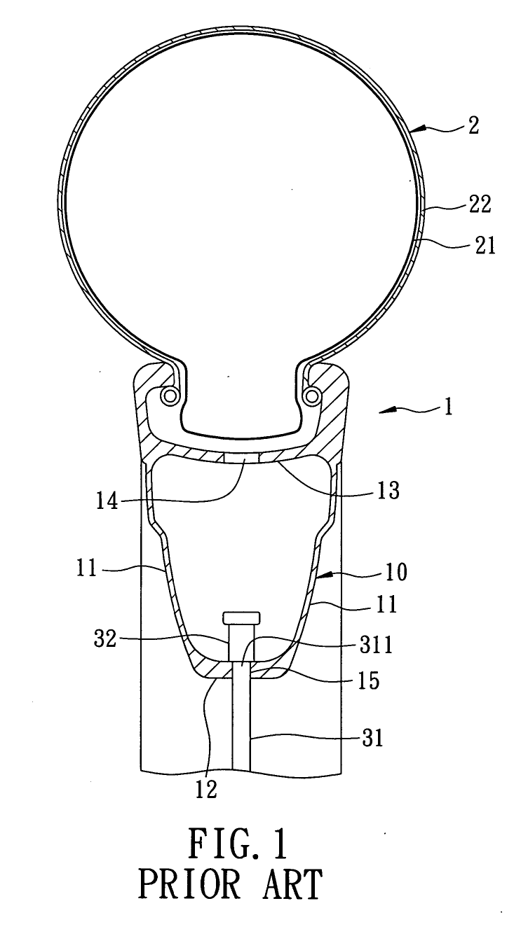

FIG. 2 is a fragmentary perspective view of the preferred embodiment of a bicycle wheel rim according to the present invention;

FIG. 3 is a schematic view of the preferred embodiment;

FIG. 4 is a sectional view of the preferred embodiment, illustrating a spoke in the act of being assembled on a wheel rim body;

FIG. 5 is a view similar to FIG. 4, but with the spoke assembled on the wheel rim body;

FIG. 6 is another sectional view of the preferred embodiment, illustrating another spoke in the act of being assembled on the wheel rim body;

FIG. 7 is a view similar to FIG. 6, but with the spoke assembled on the wheel rim body;

FIG. 8 is a fragmentary perspective view of the preferred embodiment, illustrating a cover for sealing a cutout portion;

FIG. 9 is a sectional view of the preferred embodiment, illustrating the cutout portions which are sealed by the covers; and

FIG. 10 is a view similar to FIG. 9, but with the cutout portions being sealed with alternative covers.

### DETAILED DESCRIPTION OF THE PREFERRED EMBODIMENT

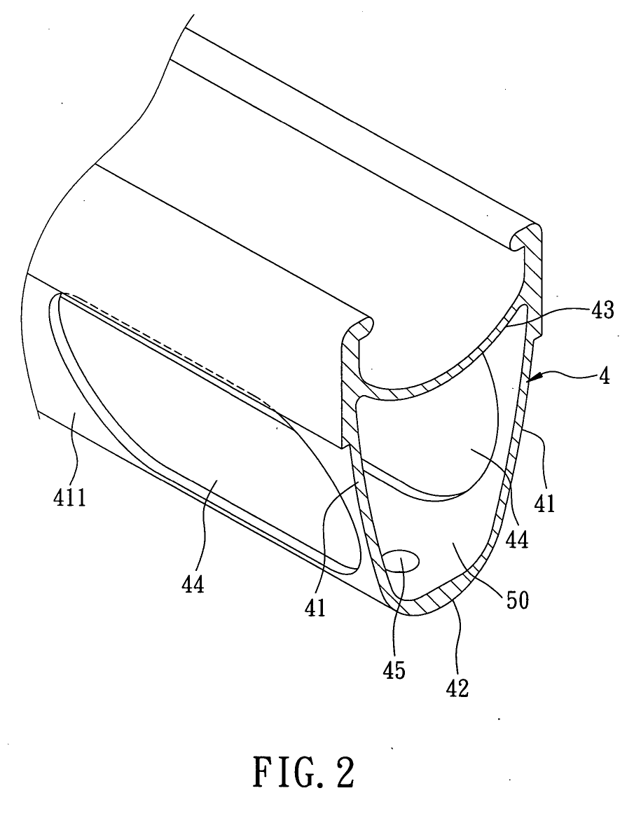

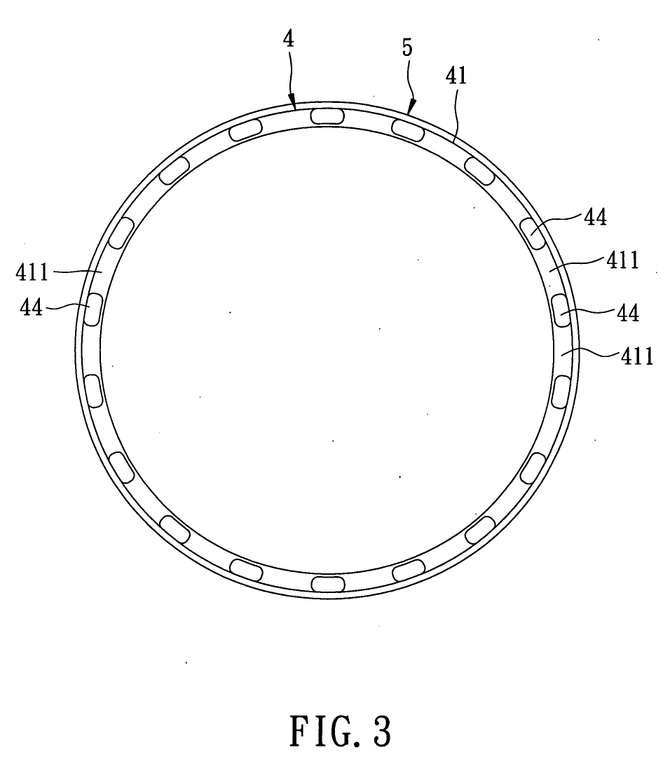

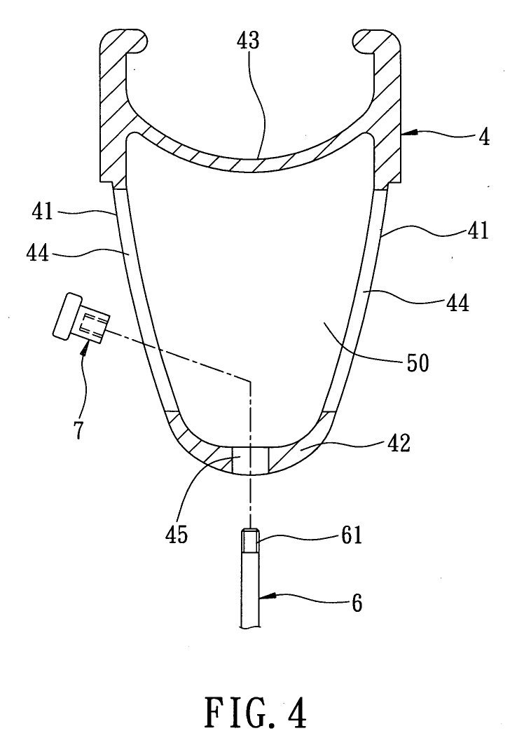

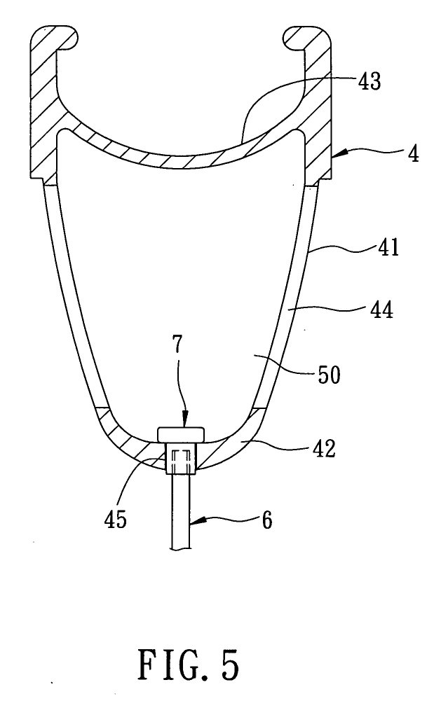

Referring to FIGS. 2 to 5, the preferred embodiment of a bicycle wheel rim according to the present invention is shown to comprise a wheel rim body 4 for assembly with a bicycle tire 5 and a plurality of spokes 6 (only one is shown in FIGS. 4 and 5).

The wheel rim body 4 has two opposite annular sidewalls 41, an annular intermediate wall 42 connected between the sidewalls 41, and an annular rib 43 connected between the sidewalls 41 opposite to the intermediate wall 42. Each of the sidewalls 41 is formed with a plurality of angularly spaced-apart cutout portions 44, and a plurality of solid portions 411 formed between and around the cutout portions 44. The intermediate wall 42 is formed with a plurality of angularly spaced-apart spoke holes 45, each of which is adapted to retain a corresponding one of the spokes 6. Each of the cutout portions 44 is elongated in a circumferential direction of the wheel rim body 4. The cutout portions 44 and the spoke holes 45 are arranged at substantially equal distances. Each of the spoke holes 45 is disposed between two opposite ones of the cutout portions 44, which are formed respectively in the sidewalls 41. Through testing, it was found that when the cutout portions 44 in each of the sidewalls 41 occupy 10 to 40% of a total area of a corresponding one of the sidewalls 41, the structural strength of the wheel rim body 4 is minimally affected by the cutout portions 44.

Since access to an interior space 50 confined by the sidewalls 41, the intermediate wall 42 and the rib 43 is permitted through the cutout portions 44, during assembly, a user's hand or a tool can be easily extended into the interior space 50 to facilitate attachment of the spokes 6 to the wheel rim body 4. Hence, an end 61 of each spoke 6 is inserted into the wheel rim body 4 via the respective spoke hole 45, after which a screw bolt 7 is engaged threadedly to the end 61 of the respective spoke 61 using a tool or by direct hand manipulation by the user. This results in the screw bolt 7 abutting against the intermediate wall 42 of the wheel rim body 4.

Since assembly of the spokes 6 on the wheel rim body 4 does not involved the bicycle tire 5, the bicycle tire 5 can be sleeved between the sidewalls 41 of the wheel rim body 4 before or after installation of the spokes 6. Particularly advantageous is that during replacement or adjustment of each spoke 6, there is no need to remove any component. The user can simply extend his hand or a tool into the interior space 50 via the corresponding cutout portion 44 to remove or install the spokes 6 from or on the wheel rim body 4.

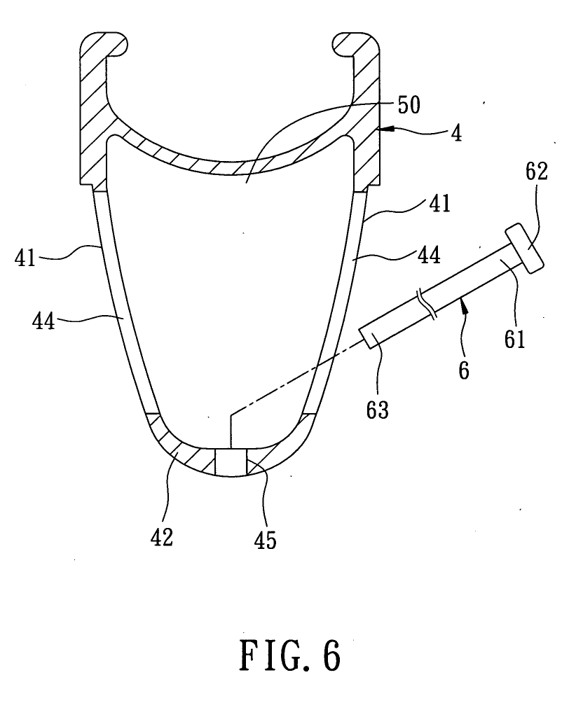

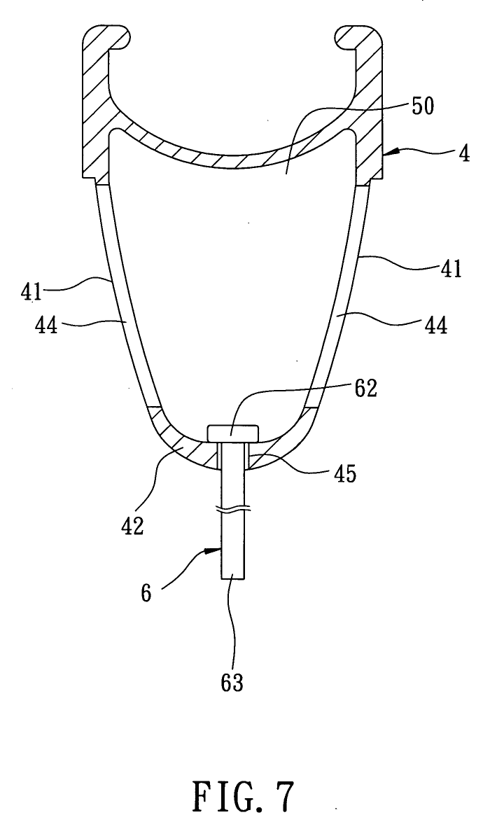

Referring to FIGS. 6 and 7, the bicycle wheel rim of the present invention is also suitable for assembly with direct connecting type of spokes 6. Each of the spokes 6 has the end 61, a bolt head 62 connected to the end 61, and another end 63 opposite to the end 61. During assembly, the end 63 of each spoke 6 passes through the corresponding cutout portion 44 and the corresponding spoke hole 45 until the bolt head 62 of each spoke 6 abuts against the intermediate wall 42 of the wheel rim body 4 and is positioned thereto. Similarly, to remove the spokes 6, the user simply extends his hand or a tool into the interior space 50 via the corresponding cutout portion 44 to remove the spokes 6 from the wheel rim body 4.

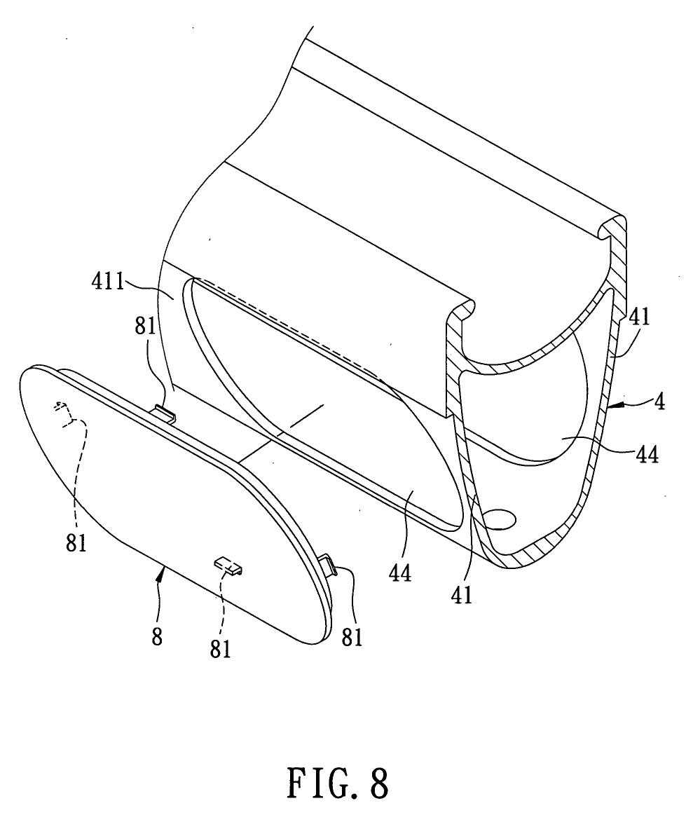

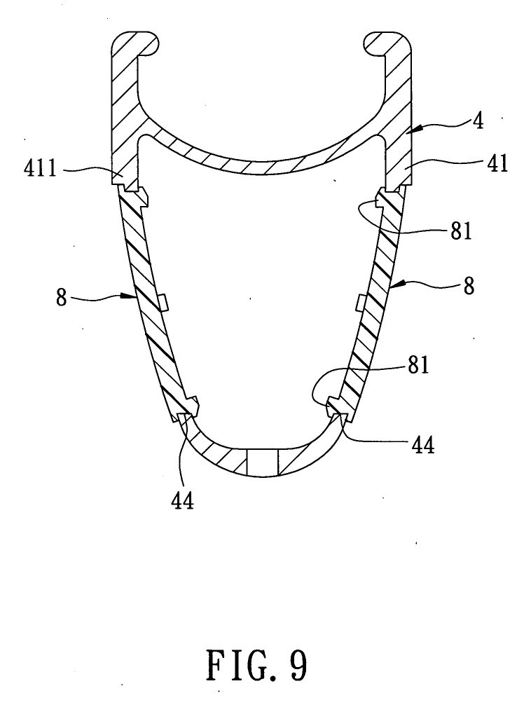

Referring to FIGS. 8 and 9, the bicycle wheel rim of the present invention further includes a plurality of covers 8, each of which seals detachably a corresponding one of the cutout portions 44. Each of the covers 8 has a plurality of engaging units 81 engaged to the solid portion 411 of the corresponding sidewall 41 to thereby position each cover 8 on the corresponding sidewall 41. A dustproof effect can therefore be achieved. Moreover, an outer appearance of the wheel rim body 4 may be enhanced by providing variety in the design and color of each cover 8.

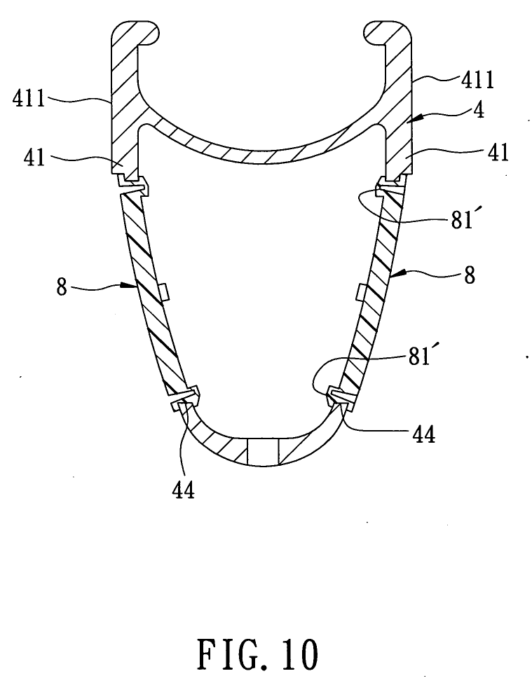

Referring to FIG. 10, in an alternative embodiment, each of the covers 8 includes a plurality of resilient engaging units 81′ through which each of the covers 8 can similarly seal detachably the corresponding cutout portion 44. The resilient engaging units 81′ of each cover 8 are engaged to the solid portion 411 of the corresponding sidewall 41. When the resilient engaging units 81′ are compressed by an external force, they can be released from engagement with the solid portion 411 of the corresponding sidewall 41. As a result, the covers 8 are easily removed from the wheel rim body 4, similarly have a dustproof effect, and can enhance the outer appearance of the wheel rim body 4.

From the aforementioned description, the advantages of the bicycle wheel rim of the present invention can be summarized as follows:

Through the presence of the cutout portions 44 in the two opposite sidewalls 41 of the wheel rim body 4, the wheel rim body 4 is made lightweight, and low in cost while maintaining a sufficient structural strength. Furthermore, the outer appearance of the wheel rim body 4 may be enhanced by varying the appearance and color of the covers 8. Most significantly, the user can extend his hand or a tool into the interior space 50 of the wheel rim body 4 through the corresponding cutout portion 44 to attach or remove each of the spokes 6 on or from the wheel rim body 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A bicycle wheel rim for assembly with a plurality of spokes, comprising:
a wheel rim body having two opposite annular sidewalls, an annular intermediate wall connected between said sidewalls, and an annular rib connected between said sidewalls opposite to said intermediate wall, said intermediate wall being formed with a plurality of angularly spaced-apart spoke holes, each of said spoke holes being adapted to retain a corresponding one of the spokes, each of said sidewalls being formed with a plurality of angularly spaced-apart cutout portions, whereby access to an interior space confined by said sidewalls, said intermediate wall and said rib is permitted through said cutout portions for attachment of the spokes to said spoke holes, respectively.

2. The bicycle wheel rim of claim 1, wherein said cutout portions and said spoke holes are arranged at substantially equal distances.

3. The bicycle wheel rim of claim 1, wherein each of said spoke holes is disposed between two opposite ones of said cutout portions, said two opposite ones of said cutout portions being formed respectively in said sidewalls.

4. The bicycle wheel rim of claim 1, wherein said cutout portions in each of said sidewalls occupy 10 to 40% of a total area of a corresponding one of said sidewalls.

5. The bicycle wheel rim of claim 1, further comprising a plurality of covers, each of which seals detachably a corresponding one of said cutout portions.

6. The bicycle wheel rim of claim 5, wherein each of said covers has a plurality of engaging units engaged to a corresponding one of said sidewalls.

7. The bicycle wheel rim of claim 1, wherein each of said cutout portions is elongated in a circumferential direction of said wheel rim body.
